(19) United States
(12) Patent Application Publication
(10) Pub. No.: US 2015/0217214 A1
(43) Pub. Date: Aug. 6, 2015

(54) FILTERING APPARATUS

(71) Applicant: KOLON INDUSTRIES, INC., Gwacheon-si, Gyeonggi-do (KR)

(72) Inventor: Heewan Moon, Seoul (KR)

(73) Assignee: KOLON INDUSTRIES, INC., Gwacheon-si, Gyeonggi-do (KR)

(21) Appl. No.: 14/429,815

(22) PCT Filed: Nov. 4, 2013
(86) PCT No.: PCT/KR2013/009881

§ 371 Date: Mar. 20, 2015

(30) Foreign Application Priority Data
Dec. 14, 2012 (KR) 10-2012-0145905

(51) Int. Cl. B01D 29/66

(52) U.S. Cl. CPC B01D 29/661

(57) ABSTRACT

Disclosed is a filtering apparatus having a simplified structure. The filtering apparatus comprises a frame structure and a hollow fiber membrane module installed therein. The frame structure comprises: an aeration unit under the hollow fiber membrane module for cleaning the hollow fiber membrane module; and a double pipe for providing a first path for permeate produced by the hollow fiber membrane module and a second path for air to be supplied to the aeration unit.

### TECHNICAL FIELD

The present invention relates to a filtering apparatus, and more particularly, to a filtering apparatus having a simplified structure.

### BACKGROUND ART

Separation methods for water treatment include a method using a filtering membrane, a method using heat or phase-change, and so on.

A separation method using a filtering membrane has a lot of advantages over the method using heat or phase-change. Among the advantages is the high reliability of water treatment since the water of desired purity can be easily and stably obtained by adjusting the size of the pores of the filtering membrane. Furthermore, since the separation method using a filtering membrane does not require a heating process, the method can be used together with microorganisms which are useful for separation process but might be adversely affected by heat.

Among the separation methods using a filtering membrane is a method using a hollow fiber membrane module comprising a bundle of hollow fiber membranes. Typically, a hollow fiber membrane module has been widely used in the field of microfiltration and/or ultrafiltration for obtaining axenic water, drinking water, super pure water, and so on. Recently, the application of the hollow fiber membrane module is extended to wastewater treatment, solid-liquid separation in a septic tank, removal of suspended solid (SS) from industrial wastewater, filtration of river, filtration of industrial water, filtration of swimming pool water, and the like.

A filtering apparatus using hollow fiber membranes may be classified into a submerged-type filtering apparatus and a pressurized-type filtering apparatus according to the operation manner thereof.

A submerged-type filtering apparatus is disclosed in Korean Laid-Open Patent Publication No. 10-2009-0043638 (hereinafter, ‘prior art’) published on May 7, 2009.

The filtering apparatus of the prior art comprises a frame structure having overall shape of cuboid and hollow fiber membrane modules installed therein.

The frame structure comprises four vertical members and four cross bars supported by the vertical members respectively.

The filtering apparatus of the prior art further comprises a water collecting pipe and lower connectors. The water collecting pipe and lower connectors are combined to the rear upper cross bar and rear lower cross bar respectively to receive the permeate discharged from the first and second headers of the hollow fiber membrane modules.

The filtering apparatus of the prior art further comprises a plurality of vertical pipes for the fluid communication between the water collecting pipe and lower connectors.

A plurality of aeration tubes are disposed under the hollow fiber membrane modules for cleaning the hollow fiber membrane modules. The filtering apparatus further comprises an air supplying pipe for providing the aeration tubes with the air through an air distributing pipe.

As generally described above, according to the prior art, the main elements of the frame structure, i.e., four vertical members and four cross bars, merely supports the hollow fiber membrane modules and does not function as a path for the flow of the permeate and/or air. Thus, it is required to further provide the filtering apparatus with the additional elements such as the water collecting pipe, lower connectors, vertical pipes, and air supplying pipe for the flow of the permeate and air, which makes the filtering apparatus more complicated, makes it difficult to manufacture it, and increases the manufacturing cost thereof.

### DISCLOSURE OF INVENTION

### Technical Problem

Therefore, the present invention is directed to a filtering apparatus capable of preventing these limitations and drawbacks of the prior art.

An aspect of the present invention is to provide a filtering apparatus having a simplified structure.

Additional aspects and features of the present invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims.

### Solution to Problem

In accordance with the aspect of the present invention, there is provided a filtering apparatus comprising: a frame structure; and a hollow fiber membrane module installed in the frame structure, wherein the frame structure comprises: an aeration unit under the hollow fiber membrane module for cleaning the hollow fiber membrane module; and a double pipe for providing a first path for permeate produced by the hollow fiber membrane module and a second path for air to be supplied to the aeration unit.

The double pipe comprises an outer pipe and an inner pipe therein. The space between the outer and inner pipes may function as the first path, and the space in the inner pipe may function as the second path.

Alternatively, the space between the outer and inner pipes may function as the second path, and the space in the inner pipe may function as the first path.

The hollow fiber membrane module comprises a first header having a first collecting space, a second header having a second collecting space, and a hollow fiber membrane between the first and second headers. The frame structure further comprises first and second cross members having longitudinal direction perpendicular to the first and second headers and the hollow fiber membrane respectively. The first and second cross members are in fluid communication with the first and second collecting space respectively. The double pipe has longitudinal direction parallel to the hollow fiber membrane, supports the first and second cross members, and is in fluid communication with the first and second cross members.

The first and second cross members are in fluid communication only with one of the outer and inner pipes.

The aeration unit comprises an intermediate pipe for receiving the air from the double pipe and a plurality of aeration tubes. The intermediate pipe distributes the air from the double pipe to the aeration tubes. The intermediate pipe is in fluid communication only with the other of the outer and inner pipes which is not in fluid communication with the first and second cross members.

It is to be understood that both the foregoing general description and the following detailed description of the present invention are exemplary and explanatory and are intended to provide further explanation of the invention as claimed.

### Advantageous Effects of Invention

Since the filtering apparatus of the present invention has a simplified structure, it can be manufactured not only more easily but also more inexpensively than the prior art.

Other advantages of the present invention will be described below in detail together with the related technical features.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of the filtering apparatus according to one embodiment of the present invention;

FIG. 2 is a cross-sectional view along the I-I′ line of FIG. 1;

FIG. 3 is a cross-sectional view along the II-II′ line of FIG. 1; and

FIG. 4 is a cross-sectional view along the line III-III′ of FIG. 1.

### MODE FOR THE INVENTION

Hereinafter, the filtering apparatus according to the embodiments of the present invention will be described in detail with reference to the annexed drawings.

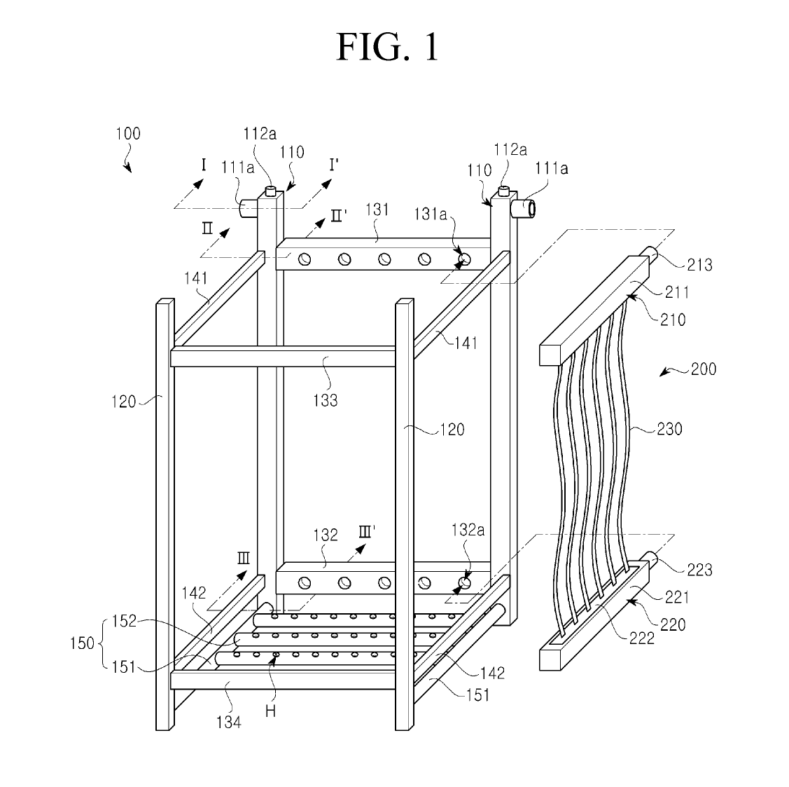

FIG. 1 is a perspective view of the filtering apparatus according to one embodiment of the present invention.

As illustrated in FIG. 1, the filtering apparatus of the present invention comprises a frame structure 100 and hollow fiber membrane modules 200. The hollow fiber membrane modules 200 are installed in the frame structure 100. The frame structure 100 comprises an aeration unit 150 disposed under the hollow fiber membrane modules 200 for cleaning the hollow fiber membrane modules 200.

Each of the hollow fiber membrane modules 200 comprises the first header 210 of elongated shape having the first collecting space, the second header 220 of elongated shape having the second collecting space, and the hollow fiber membranes 230 between the first and second headers 210, 220.

The polymer resin that can be used for manufacturing the hollow fiber membrane 230 comprises at least one of polysulfone resin, polyethersulfone resin, sulfonated polysulfone resin, polyvinylidene fluoride (PVDF) resin, polyacrylonitrile (PAN) resin, polyimide resin, polyamideimide resin, and polyesterimide resin.

The hollow fiber membrane 230 may be a single-layer membrane or a composite membrane. If the hollow fiber membrane 230 is a composite membrane, it may comprise a tubular braid and a polymer thin film coated thereon. The tubular braid may be made of polyester or nylon. The polymer thin film comprises at least one of polysulfone resin, polyethersulfone resin, sulfonated polysulfone resin, polyvinylidene fluoride resin, polyacrylonitrile resin, polyimide resin, polyamideimide resin, and polyesterimide resin.

One end of the hollow fiber membrane 230 is fixed to the body 211 of the first header 210 through the first fixing layer (not shown), and the other end thereof is fixed to the body 221 of the second header 220 through the second fixing layer 222.

The lumen of the hollow fiber membrane 230 is in fluid communication with the first and second collecting spaces of the first and second headers 210, 220. Thus, when negative pressure is supplied to the lumen of the hollow fiber membrane 230, the permeate passing through the hollow fiber membrane 230 is introduced into the first and second collecting spaces of the first and second headers 210, 220 via the lumen and then discharged through the first and second outlet ports 213, 223.

As illustrated in FIG. 1, the frame structure 100 according to the one embodiment of the present invention comprises two double pipes 110 and two vertical bars 120, all of which have longitudinal direction parallel to the hollow fiber membrane 230.

The frame structure 100 further comprises the first and second cross members 131, 132 whose both ends are combined to the two double pipes 110 respectively, and the first and second cross bars 133, 134 whose both ends are combined to the two vertical bars 120 respectively.

The first and second cross members 131, 132 and first and second cross bars 133, 134 have longitudinal direction perpendicular to the first and second headers 210, 220 as well as the hollow fiber membrane 230 of the hollow fiber membrane module 200, respectively.

Both ends of the first header 210 of the hollow fiber membrane module 200 are coupled to the first cross member 131 and the first cross bar 133 respectively, and both ends of the second header 220 of the hollow fiber membrane module 200 are coupled to the second cross member 132 and the second cross bar 134 respectively.

According to the one embodiment of the present invention, as illustrated in FIG. 1, the first cross member 131 is a kind of pipe which is in fluid communication with the first collecting space of the first header 210 of the hollow fiber membrane module 200. More particularly speaking, the first outlet port 213 of the first header 210 is inserted into the coupling hole 131a of the first cross member 131 so that the first header 210 can be supported by the first cross member 131 and, at the same time, the first collecting space of the first header 210 can be in fluid communication with the first cross member 131. Accordingly, the permeate passing through the hollow fiber membrane 230 and then introduced into the first collecting space of the first header 210 flows into the first cross member 131.

Similarly, the second cross member 132 is also a pipe which functions as a fluid path. The second outlet port 223 of the second header 220 is inserted into the coupling hole 132a of the second cross member 132 so that the second header 220 can be supported by the second cross member 132 and, at the same time, the second collecting space of the second header 220 can be in fluid communication with the second cross member 132. Thus, the permeate passing through the hollow fiber membrane 230 and then introduced into the second collecting space of the second header 220 flows into the second cross member 132.

The double pipes 110 to which both ends of the first and second cross members 131, 132 are combined respectively so that the first and second cross members 131, 132 can be supported by them provide the first path for the permeate produced by the hollow fiber membrane module 200 and the second path for the air to be supplied to the aeration unit 150, respectively.

The frame structure 100 of the present invention may further comprise horizontal members 141, 142 having longitudinal direction parallel to the first and second headers 210, 220 of the hollow fiber membrane module 200. According to one embodiment of the present invention, the horizontal members 141, 142 comprise the upper horizontal members 141 and the lower horizontal members 142 disposed under them. Both ends of each horizontal member 141, 142 are directly combined to one of the double pipes 110 and one of the vertical bars 120 respectively so that the interval between the double pipes 110 and vertical bars 120 can be kept constantly.

The aeration unit 150 disposed under the hollow fiber membrane modules 200 installed in the frame structure 100 comprises an intermediate pipe 151 and a plurality of aeration tubes 152, the intermediate pipe 151 receiving the air from the double pipe 110 for cleaning the hollow fiber membranes 230. The intermediates pipe 151 distributes the air from the double pipe 110 to the plurality of aeration tubes 152. The air introduced in the aeration tubes 152 is discharged to the feed water through the holes H formed on the aeration tubes 152, and then removes the contaminants adhered to the surface of the hollow fiber membrane 230 while moving upwardly.

According to one embodiment of the present invention, the aeration unit 150 comprises two intermediate pipes 151. Both ends of each intermediate pipe 151 are directly combined to one of the double pipes 110 and one of the vertical bars 120 respectively so that the interval therebetween can be kept constantly. Optionally, the lower horizontal members 142 which performs similar function (i.e., interval maintaining function) can be omitted.

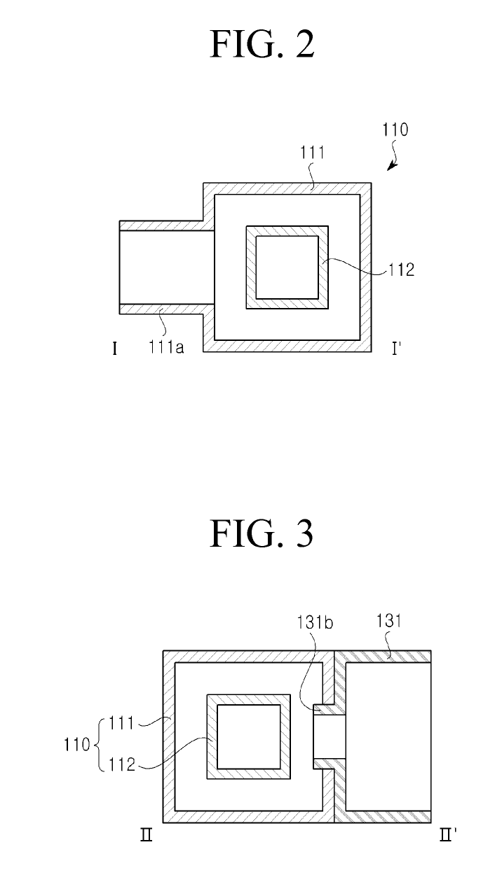

Hereinafter, the double pipe 110 of the present invention will be described in detail with reference to FIG. 2 to FIG. 4.

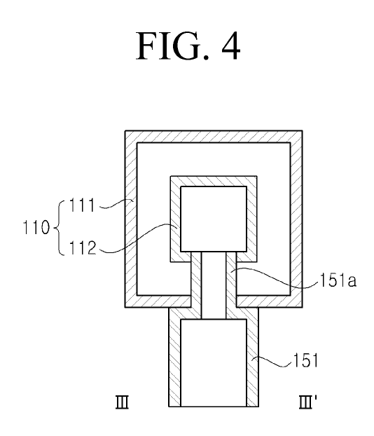

FIG. 2 is a cross-sectional view along the I-I′ line of FIG. 1, FIG. 3 is a cross-sectional view along the II-II′ line of FIG. 1, and FIG. 4 is a cross-sectional view along the III-III′ line of FIG. 1.

The double pipe 110 of the present invention comprises an outer pipe 111 and an inner pipe 112 in the outer pipe 111.

According to one embodiment of the present invention, the space between the outer and inner pipes 111, 112 functions as the first path for the permeate produced by the hollow fiber membrane module 200.

More particularly speaking, as illustrated in FIG. 3, the outer pipe 111 of the double pipe 110 is coupled to the first cross member 131 by means of the outlet port 131b of the first cross member 131 so that they are in fluid communication with each other. Although not shown, the second cross member 132 is also coupled to the outer pipe 111 of the double pipe 110 in such a manner that they are in fluid communication with each other.

Accordingly, the permeate passing through the hollow fiber membrane 230 and then introduced into the first and second collecting spaces of the first and second headers 210, 220 flows into the first path of the double pipe 110 via the first and second cross members 131, 132. Subsequently, the permeate is discharged out of the filtering apparatus through the permeate outlet port 111a of the double pipe 110 which is illustrated in FIG. 2. From a viewpoint of the negative pressure to be supplied to the hollow fiber membrane module 200 for the filtration process, the negative pressure for the filtration process is supplied to the hollow fiber membrane module 200 through the first path of the double pipe 110 and the first and second cross members 131, 132.

The space in the inner pipe 112 of the double pipe 110 functions as the second path for the air for cleaning the hollow fiber membrane 230.

More particularly speaking, as shown in FIG. 4, the intermediate pipe 151 of the aeration unit 150 is connected to the inner pipe 112 of the double pipe 110 by means of its inlet port 151a so that they can be in fluid communication with each other.

Thus, The air for the aeration cleaning introduced into the inner pipe 112 of the double pipe 110 through the air inlet port 112a of the double pipe 110 flows along the second path of the double pipe 110 and then enters the intermediate pipe 151 of the aeration unit 150. The air introduced in the intermediate pipe 151 is distributed to the plurality of aeration tubes 152. Then, the air introduced in the aeration tubes 152 is discharged to the feed water through the holes H formed on the aeration tubes 152, and then removes the contaminants adhered to the surface of the hollow fiber membrane 230 while moving upwardly.

Alternatively, according to the other embodiment of the present invention, the space between the outer and inner pipes 111, 112 may function as the second path for the air for the aeration cleaning, and the space in the inner pipe 112 may function as the first path for the permeate. In this case, the first and second cross members 131, 132 are in fluid communication only with the inner pipe 112 of the double pipe 110, and the intermediate pipe 151 of the aeration unit 150 is in fluid communication only with the outer pipe 111 of the double pipe 110.

According to another embodiment of the present invention, while one of the two double pipes 110 (hereinafter, first double pipe) is in fluid communication with the first cross member 131, the other of the two double pipes 110 (hereinafter, second double pipe) is in fluid communication with the second cross member 132. Hence, the permeate introduced in the first collecting space of the first header 210 of the hollow fiber membrane module 200 passes through the first cross member 131 and the first double pipe sequentially, and then is discharged out of the filtering apparatus. On the other hand, the permeate introduced in the second collecting space of the second header 220 of the hollow fiber membrane module 200 passes through the second cross member 132 and the second double pipe sequentially, and then is discharged out of the filtering apparatus.

According to a further embodiment of the present invention, one of the first and second cross members 131, 132 is not a pipe capable of providing a fluid path and performs only the function of supporting the corresponding header among the first and second headers 210, 220 of the hollow fiber membrane module 200. In this case, the header corresponding to the cross member performing a mere supporting function may have no collecting space therein.

According to a still further embodiment of the present invention, one of the two double pipes 110 may be replaced with a bar which does not provide a path for a fluid (i.e., permeate or air).

As described above in detail, according to the invention, the double pipes 110 and cross members 131, 132, i.e., the main elements of the frame structure 100, not only support the hollow fiber membrane modules 200 but also function as the paths for the flow of the permeate and air for aeration cleaning, thereby obviating any need for additional elements for the flow of the permeate and air. Consequently, the filtering apparatus of the invention having a simplified structure can be manufactured more easily as well as more inexpensively than the prior art.

1. A filtering apparatus comprising:
a frame structure; and
a hollow fiber membrane module installed in the frame structure,
wherein the frame structure comprises:
an aeration unit under the hollow fiber membrane module for cleaning the hollow fiber membrane module; and
a double pipe for providing a first path for permeate produced by the hollow fiber membrane module and a second path for air to be supplied to the aeration unit.

2. The filtering apparatus of claim 1, wherein the double pipe comprises:
an outer pipe; and
an inner pipe in the outer pipe,
wherein a space between the outer and inner pipes functions as the first path, and
wherein a space in the inner pipe functions as the second path.

3. The filtering apparatus of claim 1, wherein the double pipe comprises:
an outer pipe; and
an inner pipe in the outer pipe,
wherein a space between the outer and inner pipes functions as the second path, and
wherein a space in the inner pipe functions as the first path.

4. The filtering apparatus of claim 1, wherein the hollow fiber membrane module comprises:
a first header having a first collecting space;
a second header having a second collecting space; and
a hollow fiber membrane between the first and second headers,
wherein the frame structure further comprises first and second cross members having longitudinal direction perpendicular to the first and second headers and the hollow fiber membrane respectively, the first and second cross members being in fluid communication with the first and second collecting space respectively, and
wherein the double pipe has longitudinal direction parallel to the hollow fiber membrane, supports the first and second cross members, and is in fluid communication with the first and second cross members.

5. The filtering apparatus of claim 4, wherein the double pipe comprises:
an outer pipe; and
an inner pipe in the outer pipe, and
wherein the first and second cross members are in fluid communication only with one of the outer and inner pipes.

6. The filtering apparatus of claim 5, wherein the aeration unit comprises:
an intermediate pipe for receiving the air from the double pipe; and
a plurality of aeration tubes,
wherein the intermediate pipe distributes the air from the double pipe to the aeration tubes, and
wherein the intermediate pipe is in fluid communication only with the other of the outer and inner pipes which is not in fluid communication with the first and second cross members.
